(19) United States
(12) Patent Application Publication
(10) Pub. No.: US 2023/0140930 A1
(43) Pub. Date: May 11, 2023

(54) PNEUMATIC PLATE DEVICE

(71) Applicant: Mengqiang Song, Shenzhen (CN)

(72) Inventor: Mengqiang Song, Shenzhen (CN)

(21) Appl. No.: 17/747,679

(22) Filed: May 18, 2022

(30) Foreign Application Priority Data
Nov. 9, 2021 (CN) 202111316979.X

(51) Int. Cl. G09F 5/00

(52) U.S. Cl. CPC G09F 5/00

(57) ABSTRACT

The invention discloses a pneumatic plate device, comprising a plate body, and the plate body is composed of a plurality of unit plates of the same specification, the unit plate is provided with a circular opening according to the processing requirements, and all openings have the same diameter, the upper half of the unit plate is provided with a rod body base, and each rod body base is provided with a cylindrical rod body. Compared with the prior art, the invention has the advantages that the overall structure is simple and exquisite, the selection of parts, the connection method and the overall working principle are reasonable and clear, the production method and the use method are simple, the production cost and the use cost are low, the function is complete, and the durability is high, good applicability and easy promotion.

### 1. TECHNICAL FIELD

The invention relates to the field of advertisement decoration, in particular to a pneumatic plate device.

### 2. BACKGROUND ART

Most of the current pneumatic plates are small plastic modules installed on special keels, the back plate is not ventilated, the pneumatic effect is poor, the strength is poor and easily damaged, the hooks protrude from the plate surface, and it is difficult to install fonts.

### 3. SUMMARY OF THE INVENTION

The technical problem to be solved by the invention is that most of the current pneumatic plates are closed and integrated, the whole is large and cannot be assembled according to actual working conditions, which affects the appearance of the pneumatic plates and the performance of their markings on the surface, and affects their use.

In order to solve above technical problem, the invention provides the following technical scheme: a pneumatic plate device, comprising a plate body, and the plate body is composed of a plurality of unit plates of the same specification, the unit plate is provided with a circular opening according to the processing requirements, and all openings have the same diameter, the upper half of the unit plate is provided with a rod body base, and each rod body base is provided with a cylindrical rod body.

Compared with the prior art, the invention has the advantages that the overall structure is simple and exquisite, the selection of parts, the connection method and the overall working principle are reasonable and clear, the production method and the use method are simple, the production cost and the use cost are low, the function is complete, and the durability is high, good applicability and easy promotion.

Further, the unit plates are connected to each other by means of integral injection molding to form the plate body.

Further, the rod body base is embedded in the unit plate.

Further, the rod body is installed in the rod body base by means of integral injection molding.

### 4. BRIEF DESCRIPTION OF ACCOMPANY DRAWINGS

FIG. 1 is a schematic diagram of the front structure of a pneumatic plate device.

FIG. 2 is a schematic diagram of the rear structure of a pneumatic plate device.

FIG. 3 is a structure diagram of the embodiment.

As shown in the accompanying drawings: 1 unit plate, 2 opening, 3 rod body, 4 rod body base, 5 first plate body, 6 second plate body, 7 tie.

### 5. SPECIFIC EMBODIMENT OF THE INVENTION

The invention is further explained in detail in combination with the accompany drawings.

In the specific embodiments of the invention, a pneumatic plate device, comprising a plate body, and the plate body is composed of a plurality of unit plates 1 of the same specification, the unit plate 1 is provided with a circular opening 2 according to the processing requirements, and all openings 2 have the same diameter, the upper half of the unit plate 1 is provided with a rod body base 4, and each rod body base 4 is provided with a cylindrical rod body 3.

The unit plates 1 are connected to each other by means of integral injection molding to form the plate body.

The rod body base 4 is embedded in the unit plate 1.

The rod body 3 is installed in the rod body base 4 by means of integral injection molding.

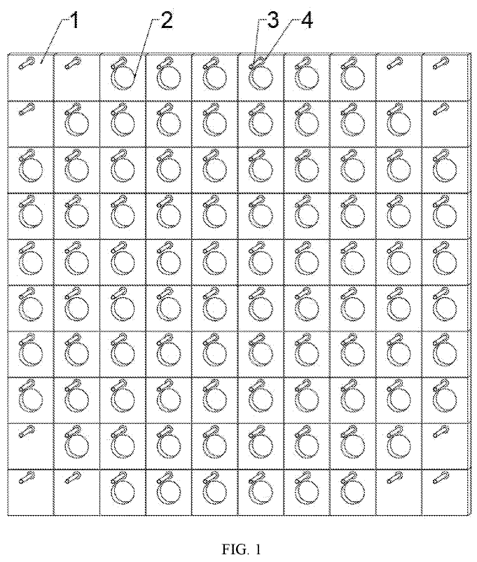

The working principle of the invention: in the embodiment shown in FIG. 1, the plate body is composed of a plurality of unit plates of the same specification, the unit plate is provided with a circular opening according to the processing requirements, and all openings have the same diameter, the upper half of the unit plate is provided with a rod body base, and each rod body base is provided with a cylindrical rod body.

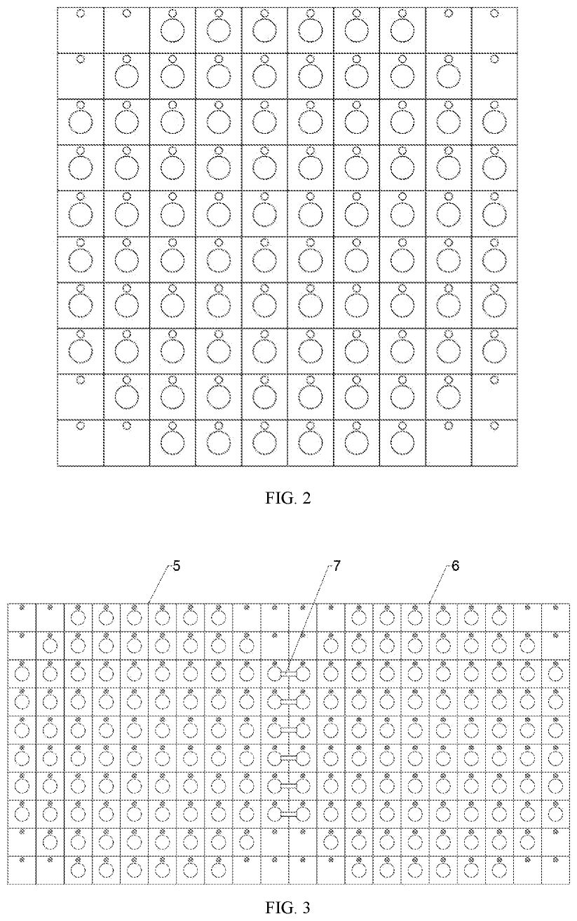

In the embodiment shown in FIG. 2, the unit plates are connected to each other by means of integral injection molding to form the plate body. The rod body base is embedded in the unit plate. The rod body is installed in the rod body base by means of integral injection molding.

In the embodiment shown in FIG. 3, the first plate body 5 and the second plate body 6 are connected by ties 7 to form a plate body with a larger area, users can assemble plate bodies of different sizes and shapes according to actual needs to meet decorative needs.

In addition, the terms of “first” and “second” are only used for descriptive purposes, and should not be construed as indicating or implying relative importance or implying the number of indicated technical features. Therefore, the features defined with “first” and “second” may expressly or implicitly include one or more of the features, and in the description of the invention, the meaning of “multiple” is two or two above, unless otherwise expressly specifically defined.

In the invention, the terms of “arrange”, “link”, “connect” and “fix” etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

In the invention, the first feature “above” or “below” the second feature may include the first feature and second feature in direct contact, or may include the first feature and second feature not in direct contact but in contact through additional feature between them unless there are specific restrictions or stipulations. Moreover, the first feature being “on”, “above” and “over” the second feature includes the first feature being directly above and obliquely above the second feature, or simply means that the first feature has a higher level than the second feature. The first feature is “under”, “below” and “underneath” the second feature includes the first feature is directly below and diagonally below the second feature, or simply means that the first feature has a lower level than the second feature.

In the description of the specification, the reference terms “one embodiment”, “some embodiments”, “example”, “specific example”, “some examples” and etc., may refer to that the specific features, structures, materials or characteristics described by combining the embodiment or example are included in at least one embodiment or example. In the specification, schematic statement of above terms does not necessarily refer to the same embodiment or example. In addition, the described specific features, structures, materials, or characteristics may be combined in any one or more embodiments or examples in an appropriate manner.

Although the embodiments of the invention have been shown and described above, it should be understood that the above embodiments are exemplary and should not be construed as limiting the invention. Those skilled in the art can make changes, modifications, substitutions and alterations to the above-described embodiments within the scope of the invention without departing from the principles and spirit of the invention.

1. A pneumatic plate device, comprising a plate body, and the plate body is composed of a plurality of unit plates (1) of the same specification, the unit plate (1) is provided with a circular opening (2) according to the processing requirements, and all openings (2) have the same diameter, the upper half of the unit plate (1) is provided with a rod body base (4), and each rod body base (4) is provided with a cylindrical rod body (3).

2. A pneumatic plate device of claim 1, the unit plates (1) are connected to each other by means of integral injection molding to form the plate body.

3. A pneumatic plate device of claim 1, the rod body base (4) is embedded in the unit plate (1).

4. A pneumatic plate device of claim 1, the rod body (3) is installed in the rod body base (4) by means of integral injection molding.
